(19) United States
(12) Patent Application Publication
(10) Pub. No.: US 2016/0125545 A1
(43) Pub. Date: May 5, 2016

(54) SYSTEM AND METHOD FOR DETERMINING LIFETIME EVENTS FROM DATA SOURCES

(71) Applicant: New York Life Insurance Company, New York, NY (US)

(72) Inventors: Dawn Behrens, Mamaroneck, NY (US); Adam D. Feit, Brooklyn, NY (US); Sean Hebron, Middle Village, NY (US); Craig DeSanto, New York, NY (US)

(21) Appl. No.: 14/715,154

(22) Filed: May 18, 2015

Related U.S. Application Data
(60) Provisional application No. 61/994,476, filed on May 16, 2014.

(51) Int. Cl. G06Q 40/08

(52) U.S. Cl. CPC G06Q 40/08

(57) ABSTRACT

A system for utilizing personal data, the system comprising a server comprising a processor, and a memory having executable instructions stored thereon that when executed by the processor cause the processor to receive personal information from a client device, the personal information including a plurality of protection goals of an individual, match coverage to the protection goals, determine benefit profile components based on the matched coverage, generate a lifetime benefit profile based on the benefit profile components, issue an insurance policy based on the lifetime benefit profile, identify lifetime events associated with the personal information, and monitor for data associated with the lifetime events.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The invention described herein relates to tracking lifetime events, and more particularly to methods and systems for monitoring lifetime events through data sources from third parties to accommodate changing needs.

2. Description of the Related Art

A wealth of information may be found on the Internet. Online third party systems can capture large volumes of information from various sources. Information stored by the third party systems can have a time associated with it and typically, information about a user may be displayed through a profile web page that is divided into sections, each section containing different types of information pertaining to the user. For example, a user's profile page may have separate sections for educational information, interests, status updates, and hobbies, as well as a section containing thumbnails of photos of the user, and links to the user's friends. In addition, online third party systems have provided a source of real-time information.

Various consumer services are often limited given their static nature of which service contracts can be inconsistent with the customer's fluid lifetime events. For example, a common limitation of currently available life insurance policies is that they typically fail to conform to changing protection needs of the insured. By way of example, a person may acquire a first insurance policy when they need the most protection. Their insurance needs, however, after issuance of the first insurance policy can change with events such as the attainment of retirement, paying off a mortgage, when a child completes college, etc. As such, there currently exists a need for flexible services based on changes in an individual's needs and lifestyle.

### SUMMARY OF THE INVENTION

The present invention provides a system for utilizing personal data. According to one embodiment, the system comprises a server comprising a processor, and a memory having executable instructions stored thereon that when executed by the processor cause the processor to receive personal information from a client device, the personal information including a plurality of protection goals of an individual, match coverage to the protection goals, determine benefit profile components based on the matched coverage, generate a lifetime benefit profile based on the benefit profile components, issue an insurance policy based on the lifetime benefit profile, identify lifetime events associated with the personal information, and monitor for data associated with the lifetime events.

In certain embodiments, the processor is configured to monitor data from at least one third party servers. The processor may be further configured to determine at least one of online accounts and user profiles based on the personal information. According to another embodiment, the processor is configured to retrieve data from at least one of financial institute and credit bureau servers. The processor may retrieve at least one of loan status and credit scores.

The personal information may include coverage needs for one or more situations over specified durations of a lifetime. The protection goals may include at least one of income replacement, mortgage protection, education funding, final expenses, family legacy, unplanned expense cushion, childcare, healthcare and items as specified by the individual. In one embodiment, the benefit profile components include models of benefit amounts over a given lifetime based on the protection goals. The benefit profile components may include rate of change and duration properties. The lifetime benefit profile may include a total coverage from the benefit profile components. The processor is also further operable to determine flat premium payments over a payment period for the insurance policy based on the matched coverage.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a computing system according to an embodiment of the present invention;

FIG. 2 illustrates a flowchart of a method for providing custom coverage life insurance based on changing protection needs of an individual over a lifetime according to an embodiment of the present invention;

FIG. 3 illustrates exemplary coverage criteria used to determine insurance coverage according to an embodiment of the present invention;

FIG. 4 illustrates exemplary benefit profile components according to an embodiment of the present invention;

FIG. 5 illustrates an exemplary coverage life profile according to an embodiment of the present invention; and

FIG. 6 illustrates a flowchart of a method for determining the benefit amount of a policy according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part. Embodiments of the present invention described herein can be used to maintain and service an insurance policy. However, the present invention may be applied to various other products and services, and is not intended to be limited to insurance products.

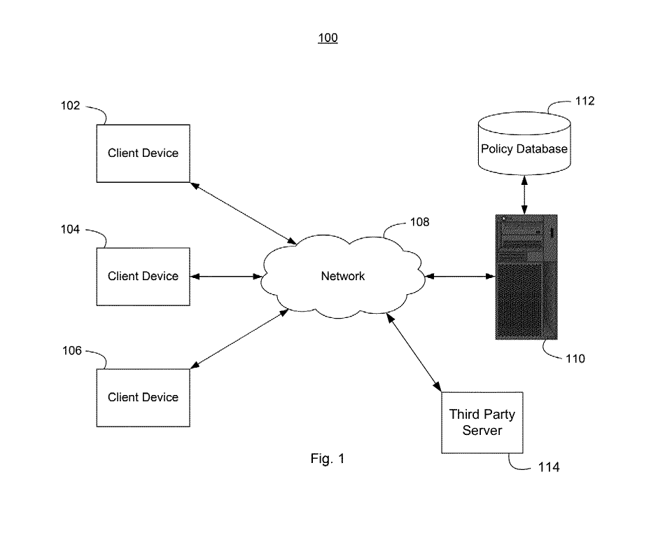

FIG. 1 presents a computing system useful in providing, underwriting, and generating insurance policies according to an embodiment of the present invention. System 100 includes client devices 102, 104 and 106, each of which includes at least a processor, memory, a display device, and an input device. The client devices 102, 104, and 106 may comprise general purpose computing devices (e.g., personal computers, mobile devices, terminals, laptops, personal digital assistants (PDA), cell phones, tablet computers, or any computing device having a central processing unit and memory unit capable of connecting to a network) having appropriate software or otherwise designed to compute or assist in computing insurance premiums according to the methods described herein. A client device may also include or execute a variety of operating systems, including a personal computer operating system, such as a Windows, Mac OS or Linux, or a mobile operating system, such as iOS, Android, or Windows Mobile, or the like. A client device may include or may execute a variety of possible applications, such as a client software application enabling communication with other devices. The software may be installed locally at the client devices, thereby enabling a user, such a broker, agent, or potential policy holder, to input information obtained regarding an insurance policy, and to compute or assist in computing a premium for an insurance policy given a selected or specified coverage amount, protection goals and/or future protection needs, which is described in further detail below. The software may be proprietary software designed to provide the methods described herein or, alternatively, commonly available software, such as spreadsheet or database programs, adopted to perform the same. Client devices 102, 104 and 106 may also comprise graphical user interfaces (GUI) or a browser application provided on a display (e.g., monitor screen, LCD or LED display, projector, etc.).

In the embodiment illustrated in FIG. 1, client devices 102, 104 and 106 are communicatively connected to at least one server 110 over a communications network 108. Network 108 may be any suitable type of network allowing transport of data communications across thereof. The network 108 may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. In one embodiment, the network may be the Internet, following known Internet protocols for data communication, or any other communication network, e.g., any local area network (LAN), or wide area network (WAN) connection, wire-line type connections, wireless type connections, or any combination thereof. Communications and content stored and/or transmitted may be encrypted using the Advanced Encryption Standard (AES) with a 256-bit key size, or any other encryption standard known in the art.

Server 110 may include one or more central processing units and memory. The server 110 may also include one or more mass storage devices, one or more power supplies, one or more wired or wireless network interfaces, one or more input/output interfaces, or one or more operating systems, such as Windows Server, Mac OS X, Unix, Linux, FreeBSD, or the like. Server 110 includes at least one database, such as a policy database 112. The policy database 112 generally includes information useful for issuing and providing an insurance contract, such as personal information, insurance variables, insurance options, etc. In one embodiment, the client devices 102, 104 and 106 may access the relevant database or databases, stored locally at the client devices or remotely at the server 110, for information necessary to compute or otherwise determining the premium or price of the insurance contract, and may update the relevant databases accordingly. Similarly, the client devices 102, 104 and 106 may access the policy database 112 to compute death benefits, surrender values, and any other insurance-related computations described herein. The system further includes third party server 114. Third party server 114 may be accessed by server 110 to retrieve data associated with lifetime events of individuals associated with one or more policies in policy database 112. The third party server 114 may be any one of search engine, directory, publication, public records, financial institute, and credit bureau servers, for example.

The methods and systems according to the present invention may be applied equally to any type of life insurance, such as a term, whole life, universal life, etc. Therefore, although the methods and systems herein will be discussed by way of example in relation to certain types of insurance, it is understood that the present invention is not limited thereto.

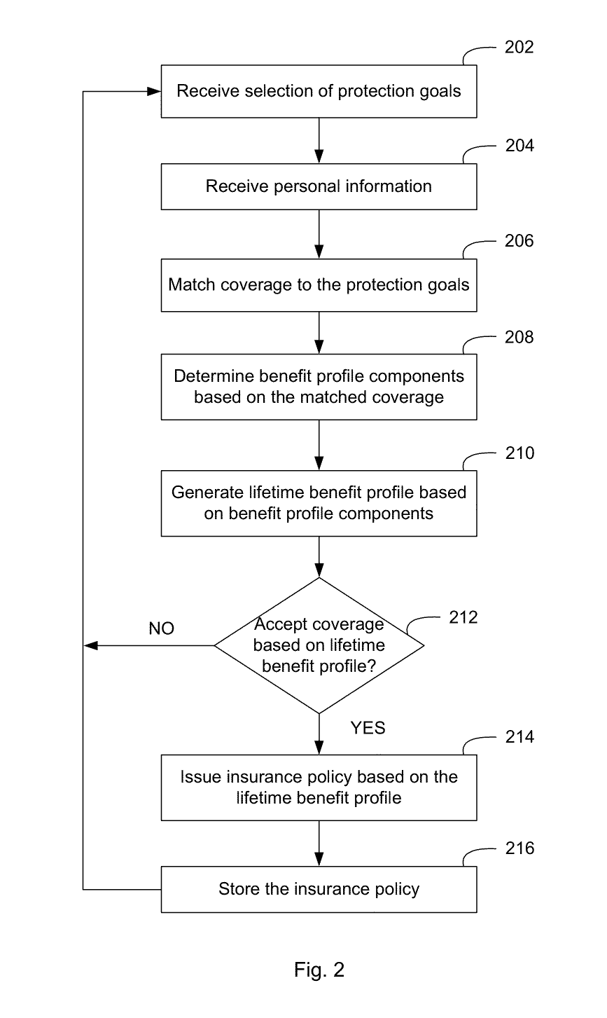

FIG. 2 presents a flowchart of a method for providing custom coverage life insurance based on changing protection needs of a policy holder over a lifetime according to an embodiment of the present invention. Custom coverage life insurance may provide a permanent insurance having a level premium for the life the policy. In alternative embodiments, custom coverage life insurance may instead provide a term life insurance. The custom coverage life insurance includes a coverage profile that matches directly to the individual needs and lifetime events of an individual. By recognizing that after each year a policy owner may no longer need certain coverage for that year, such as expenses and income, the custom coverage life insurance offers a more affordable coverage profile allowing the insurance provider to offer the product at a competitive level premium. As a permanent life insurance product, the custom coverage life insurance guarantees insurance coverage in the future and may additionally be built on a guaranteed chassis as long as premiums are paid, though coverage amount may vary if not a guaranteed product.

Agents of an insurance provider may initiate a needs analysis for individuals on an insurance policy generation system, as described with respect to FIG. 1, and recommend benefit coverage amounts for one or more lifetime scenarios. The agent may use “fact finder” questions to estimate the individual's coverage requirements over time. In step 202, a selection of protection goals are received. The individual may elect one or more protection goals to indicate his/her coverage needs. Protection goals may specify coverage needs for various situations over specified durations for a lifetime of an insurance policy or the individual. The situations may include lifetime events that directly affect and change the amount of benefit coverage needed by the individual. Examples of protection goals include income replacement, mortgage protection, education funding, final expenses, family legacy, unplanned expense cushion, and other outstanding debt.

Subsequently, personal information is received, step 204. Personal information may include information such as name, age, date of birth, gender, marital status, address or state of residence, spousal information, financial dependents, retirement age, etc. The protection goals and personal information is used to match coverage to the protection goals, step 206. Custom coverage life insurance according to embodiments of the present invention provides coverage matching to an individual's changing needs. The present invention overcomes the obstacle of being “unsure how much to buy” by matching coverage directly to the primary reasons the individual is purchasing insurance, providing the right amount of coverage at the right time for the policy holder. Coverage providing benefit amounts for each protection goal may be selected for a customized amount or determined based on an estimated need. The benefit amounts may also incorporate shifting needs over time.

Benefit profile components are determined based on the matched coverage, step 208. Lifetime needs are established for each category of protection goals in the benefit profile components. A benefit profile component may include a model of benefit amounts over a given lifetime based on a particular protection goal. In one embodiment, benefit profile components may have rate of change and duration properties. For example, a benefit profile component for mortgage protection may have a “decaying” benefit amount that declines over a period equal to the term of the mortgage or years remaining on the mortgage while a benefit profile component for final expenses may have a flat benefit amount over the duration of a lifetime.

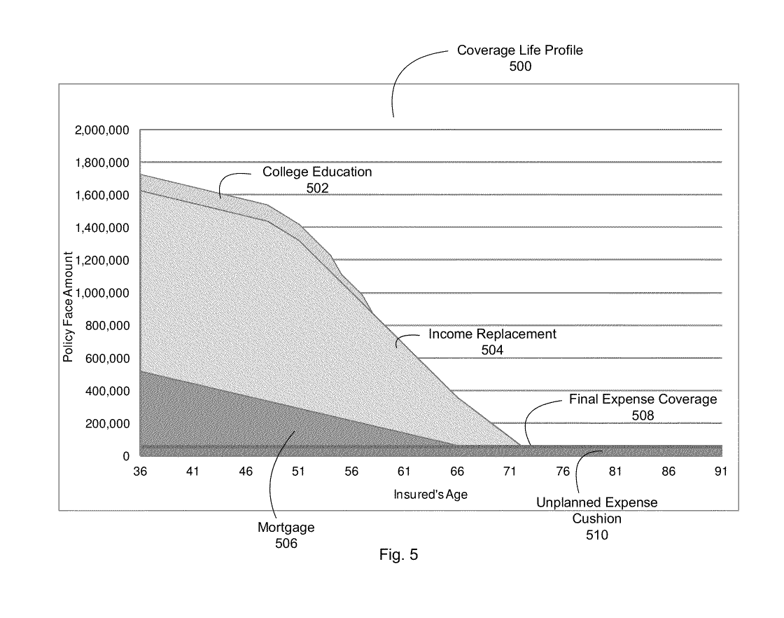

The lifetime needs established by each of the benefit profile components may be aggregated to determine a complete lifetime benefit profile of the individual. Accordingly, a lifetime benefit profile is generated based on the benefit profile components, step 210. The lifetime benefit profile is representative of a total benefit amount based on all the protection goals specified by the individual over a lifetime. The lifetime benefit profile may be presented to the individual in visual presentation including one or more charts, graphs, spreadsheets, tables, schedules, etc., comprising the coverage associated with the various protection goals selected by the individual. The visual presentation may identify the total benefit amounts as well as a breakdown of the coverage associated with the various protection goals, which is described in further detail with respect to the description of FIG. 5.

Generating the lifetime benefit profile may also include calculating a premium based on the coverage provided based on the lifetime benefit profile. By recognizing that after each year a policy owner no longer needs certain coverage for that year, an affordable custom coverage life insurance policy may be issued. The policy owner may accept coverage based on the lifetime benefit profile, step 212. Otherwise, the lifetime benefit profile may be discarded or saved for subsequent retrieval and a new set of protection goals may be received by the insurance policy generation system. Upon acceptance an insurance policy is issued based on the lifetime benefit profile, step 214. The insurance policy may be stored (step 216) in a policy database(s).

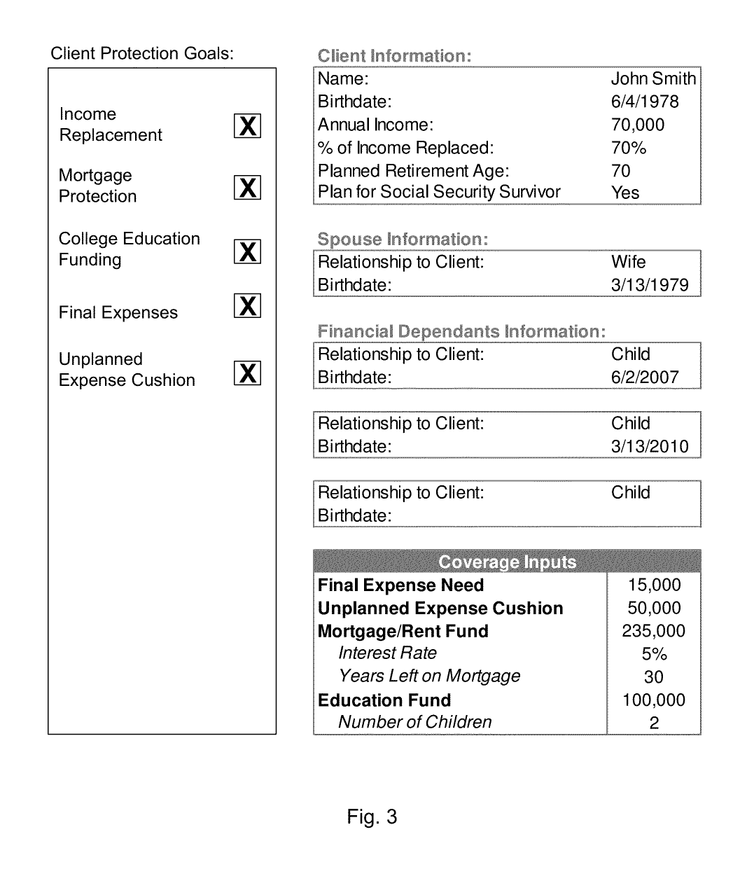

FIG. 3 presents exemplary coverage criteria of a client (individual) used to determine insurance coverage according to an embodiment of the present invention. The coverage criteria may be generated from the client's protection goals and personal information. Personal information including spousal and children information containing names and birthdays may be provided by the client from a client device. The personal information may further include mortgage or loan information associated with the client. According to one embodiment of the present invention, the personal information provided by the client may be used to retrieve and monitor for data associated with lifetime events related to the client from public databases, banks, insurance companies, etc. Loan status, credit scores, divorce or marriage filings, death certificates, liens, arrests, and job status are some exemplary types of data that may be retrieved to determine lifetime events. Lifetime events may include a child's graduation, paying off a loan or mortgage, job placement or promotion, etc. Additionally, the personal information may be utilized by a server to seek online accounts and user profiles associated with individuals provided in the personal information.

In the illustrated example, John Smith is 36 years old, married and has 2 children. John wants to purchase life insurance protection but is unsure exactly how much coverage is appropriate. He earns $70,000 annually and plans to retire at age 70. He would like to replace his income if he dies prematurely. In the event of his death, future income may be provided up to retirement that replaces John's potential income up until his desired retirement age (e.g., 70% of $70,000 salary to age 70).

He is planning to pay for a portion of his children's college education and wants protection to provide $100,000 for education costs if he dies prematurely. An education fund may be set aside money to help pay for his children's college tuition. John has 30 years left on a mortgage and wants protection to provide $235,000 to pay off the remaining mortgage on his home if he dies prematurely. John would also like $15,000 in protection for final expenses and a $50,000 in protection as an unplanned expense cushion. A final expense fund can be used to cover bills and expenses presented after John's death, most commonly funeral expenses.

In the illustrated example, John would require over $1,725,000 in total coverage at the day of issuance to be completely protected. However, many components of John's needs would decline over time including income replacement, mortgage protection, and college funding. John would not need to replace income earned in past years. Mortgage debt should decline over the life of the loan. College funding would no longer be necessary after a child's education has been completed.

For example, at 36 years old, John's protection needs are high including future income, mortgage, college education funding, final expenses, and an unplanned expense cushion. At 57 years old, both of John's children have graduated college and his mortgage is almost paid off. He now only needs to protect less of future income, less of his mortgage, final expenses and the unplanned expense cushion. At 72 years old, John would be retired and his mortgage is completely paid off. He would only need to protect final expenses and the unplanned expense cushion. As such, benefit amounts associated with protection components may be configured in a custom coverage life insurance policy, according to an embodiment of the present invention, to decline over the lifetime of the client to accommodate for the unnecessary coverage and generate savings on the insurance premium.

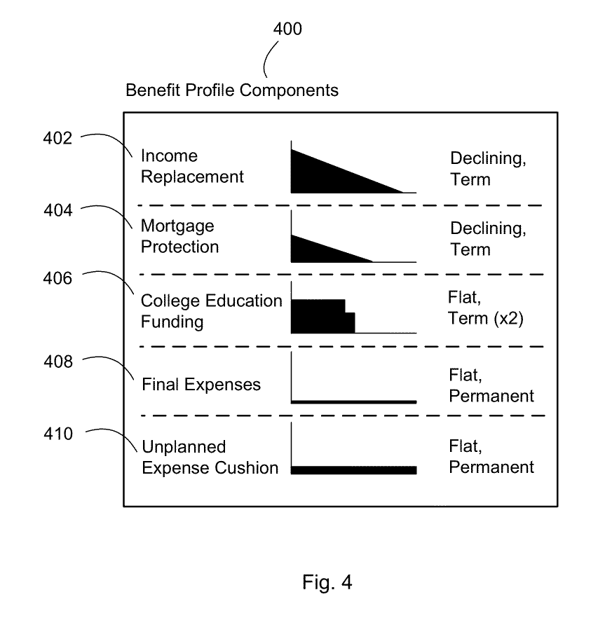

FIG. 4 presents exemplary benefit profile components according to an embodiment of the present invention. Coverage for a custom coverage life insurance policy may be determined using one or more benefit profile components. The benefit profile components may dictate how much coverage is provided by each of the protection goals over a lifetime of an individual. Benefit profile components may be generated based on the individual's protection goals and/or personal information. Using the earlier example, John Smith's protection goals may be matched to benefit profile components 400. Benefit profile components 400 includes income replacement component 402, mortgage protection component 404, college education funding component 406, final expenses component 408, and unplanned expense cushion 410. Each benefit profile component specifies coverage associated with a given protection goal over time. Other exemplary categories may include childcare expenses, healthcare, or any other discrete items that the client may specify.

Income replacement component 402 dictates declining coverage over a specified term (e.g., retirement age). Mortgage protection component 404 dictates declining coverage over a specified term (e.g., term of the mortgage). College education funding component 406 dictates flat coverage based on two terms. John has two children and desires coverage for each child until they graduate. During a first term (before both children graduate from college) a first amount of coverage that remains flat may be provided to fund college education for both children. Upon a second term (after one child graduates from college) the coverage may be reduced to a second amount that remains flat until the last child graduates from college. Final expenses component 408 and unplanned expense cushion 410 remains flat for a permanent duration or lifetime.

One or more benefit profile components may be aggregated or combined to generate a full coverage life profile. A fully coverage life profile may be used to represent total coverage and determine a policy face amount for a custom coverage life insurance policy. The total coverage of the custom coverage life insurance policy may be customized to match the individual's needs over a lifetime. In one embodiment, benefit profile components may be predefined based on the characteristics associated with a variety of protection needs and/or customized according to criteria based on needs selected by the individual.

To aid the individual in understanding what coverage he/she is buying, a visualization of the full coverage life profile may be provided as illustrated in FIG. 5. FIG. 5 presents an exemplary coverage life profile according to an embodiment of the present invention. Again, using the earlier example, coverage life profile 500 includes policy face amounts from college education 502, income replacement 504, mortgage 506, final expense coverage 508, and unplanned expense cushion 510 over a projected lifetime (e.g., of an insured individual—age 91 for John Smith). College education 502 includes a college fund portion of the total policy face amount (up to an estimated age 59 of the insured) provided by a custom coverage life insurance policy based on the coverage life profile 500. Income replacement 504 includes an income replacement portion of the total policy face amount up to and including the insured's planned retirement age (age 70 for John Smith). Mortgage 506 includes a mortgage protection portion of the total policy face amount for a duration equal to the term of the mortgage (30 years). Final expense coverage 508 includes a final expense coverage portion of the total policy face amount and unplanned expense cushion 510 includes an unplanned expense cushion portion of the total policy face amount.

Custom coverage life insurance according to embodiments of the present invention provides a benefit that adapts to John's protection needs over time. In the illustrated example, coverage will decline as John's needs decline to insure he always has the right amount of coverage over his lifetime. According to an embodiment of the present invention, the total coverage over an estimated lifetime of a policy holder is based on assumptions at the time of policy purchase and produces flat premium payments over a payment period or the life of the coverage life insurance policy. A declining benefit profile with a level premium may provide a more affordable way to get the coverage John needs without paying for unnecessary coverage.

The premium rate for the custom coverage life insurance policy may be based on two underlying concepts: mortality and interest. A third variable is the expense factor which is the amount the company adds to the cost of the policy to cover operating costs of selling insurance, investing the premiums, and paying claims. The required policy premium can be structured so that at issue, the present value of expected future premiums is equal to the present value of expected future death claims, non-forfeiture and surrender benefits, and operating expenses. The probability that an insured will incur a claim in any given year may be based on many factors, including (but not limited to) age, gender, health history, current medical conditions, motor vehicle record, years since policy issue, as well as the likelihood that the insured will have maintained the policy in good standing. The expected death claims in a given year can be equal to product of the probability that the insured will incur a claim in a given year, multiplied by the amount of coverage under the policy in that year. Each year's expected death claims are discounted at an interest rate determined by the life insurer to determine the present value of all death claims. The policy may also provide for surrender or endowment benefits at a certain age, provided that the insured has maintained the policy in good standing until that point. Expected premiums may be a function of factors such as the amount and timing of premium payments, and the likelihood that each premium payment is made. Each year's expected premiums may be discounted at an interest rate determined by the life insurer to determine the present value of all premiums.

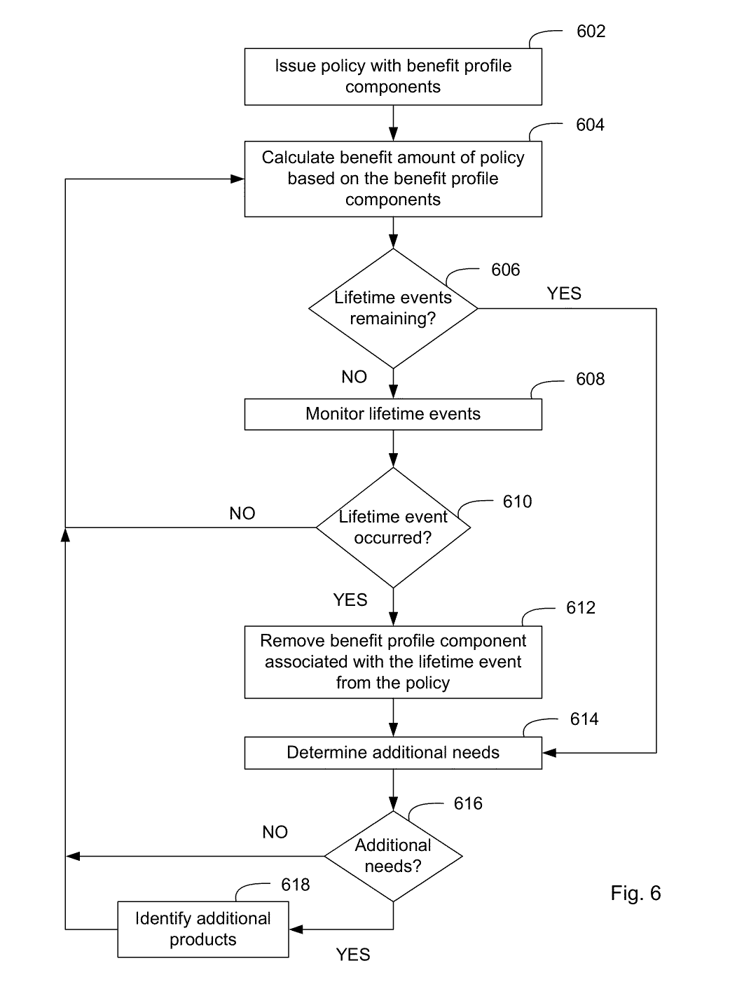

FIG. 6 presents a flowchart of a method for determining the benefit amount of a policy according to an embodiment of the present invention. A policy with benefit profile components is issued, step 602. The policy may be a custom coverage life insurance policy with one or more benefit profile components. A benefit amount of the policy is calculated based on the benefit profile components, step 604. Each benefit profile component may include benefit amounts for given periods during the life of the custom coverage life insurance policy. The benefit amount of the policy can be calculated by combining the benefit amounts from all the benefit profile components for a given period.

Remaining lifetime events associated with the policy may be detected, step 606. The lifetime events may include dates of when coverage associated the benefit profile components has decreased to zero or is no longer provided by the policy. Alternatively, lifetime events may include dates of when benefit amounts associated with the benefit profile components is adjusted to a new benefit value and/or a new rate of change (e.g., to account for a first child graduating from college). The detected lifetime events associated with the policy are monitored, step 608. Lifetime events may be periodically monitored or a notification of lifetime events may be triggered upon at least one of determining a certain date has elapsed and receiving an indication, data or message from the policy holder (via a client device) that a lifetime event has occurred. According to one embodiment, a server may be configured with personal information of the policy holder to retrieve certain data from third party databases or websites to determine achievements of lifetime events.

If a lifetime event has not occurred in step 610, the method proceeds to step 604 to calculate the benefit amount of the policy. The benefit amount of the policy may be calculated periodically (e.g., monthly, annually, etc.) to update the benefit amount to account for the gradual change in coverage based on the benefit profile components associated with the policy. Otherwise, a determination is made that a lifetime event or events (monitored in step 608) has occurred, step 610. The benefit profile component(s) associated with the lifetime event(s) are removed from the policy, step 612. Removing the benefit profile component(s) may comprise reducing the benefit amount of the benefit profile component(s) to zero.

Additional needs are determined, step 614. A reduction of coverage provides a policy holder the opportunity to assess whether new coverage levels meet all needs. Additional needs can create second sale opportunities. While custom coverage life insurance is designed to address a policy holder's changing protection needs over time, there still may be many scenarios where new needs are created. For example, accumulation needs tend to grow as a policy holder ages and become more concerned about retirement and leaving behind a legacy. As coverage declines, customers' needs may shift from protection to accumulation. In addition, new and unexpected protection needs may develop such as a change in financial dependents of the policy holder. According to one embodiment, the policy holder may convert the existing policy to a cash accumulation policy or maintain a higher amount of coverage (e.g., up to the maximum original benefit).

In addition, a custom coverage life insurance profile reveals lifetime events (e.g., when a child completes college or a mortgage matures). When these major events pass, a policy holder's budget and needs change. This knowledge allows the insurance policy generator system to assist the insurance provider or agent to take action at the most attractive times for a second sale. If available, additional needs are determined for the policy holder of the custom coverage life insurance in step 616. Additional products are identified for the additional needs, step 618. Identifying additional products may include searching a database of products or offerings suitable to accommodate changes in lifetime events. For example, a custom coverage life insurance policy may be supplemented with a variable universal life or a whole life policy to meet accumulation needs.

The additional products may be generated by the insurance policy generation system and recommended to the policy holder. In one embodiment, the insurance policy generation system may proactively alert insurance agents and/or policy holders to provide tailored policies based on the determined additional needs. The method may proceed to recalculate the benefit amount of the policy in step 604 after the identification of additional products (step 618) or if there are no additional needs determined in step 616. The recalculation may calculate reduction of policy face amount according to the benefit component profiles. If there are no remaining lifetime events associated with the policy detected in step 606, the method proceeds to step 614 to determine additional needs of the policy holder.

FIGS. 1 through 6 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A system for utilizing personal data, the system comprising:
a server comprising:
a processor; and
a memory having executable instructions stored thereon that when executed by the processor cause the processor to:
receive personal information from a client device, the personal information including a plurality of protection goals of an individual;
match coverage to the protection goals;
determine benefit profile components based on the matched coverage;
generate a lifetime benefit profile based on the benefit profile components;
issue an insurance policy based on the lifetime benefit profile;
identify lifetime events associated with the personal information; and
monitor for data associated with the lifetime events.

2. The system of claim 1 wherein the processor is further configured to monitor data from at least one third party website servers.

3. The system of claim 2 wherein the processor is further configured to determine at least one of online accounts and user profiles based on the personal information.

4. The system of claim 1 wherein the processor is further configured to retrieve data from at least one of financial institute and credit bureau servers.

5. The system of claim 4 wherein the processor is further configured to retrieve at least one of loan status and credit scores.

6. The system of claim 1, wherein the personal information includes coverage needs for one or more situations over specified durations of a lifetime.

7. The system of claim 1 wherein the protection goals include at least one of income replacement, mortgage protection, education funding, final expenses, family legacy, unplanned expense cushion, childcare, healthcare and items as specified by the individual.

8. The system of claim 1 wherein the benefit profile components include models of benefit amounts over a given lifetime based on the protection goals.

9. The system of claim 1 wherein the benefit profile components include rate of change and duration properties.

10. The system of claim 1 wherein the lifetime benefit profile includes a total coverage from the benefit profile components.

11. The system of claim 1 wherein the processor is further operable to determine flat premium payments over a payment period for the insurance policy based on the matched coverage.
